(19) United States
(12) Patent Application Publication
(10) Pub. No.: US 2013/0136403 A1
(43) Pub. Date: May 30, 2013

(54) OPTICAL MODULE

(71) Applicants: Nobuyuki YASUI, Chiyoda-ku (JP); Keita Mochizuki, Chiyoda-ku (JP)

(72) Inventors: Nobuyuki YASUI, Chiyoda-ku (JP); Keita Mochizuki, Chiyoda-ku (JP)

(73) Assignee: Mitsubishi Electric Corporation, Chiyoda-ku (JP)

(21) Appl. No.: 13/475,308

(22) Filed: May 18, 2012

(30) Foreign Application Priority Data
Nov. 29, 2011 (JP) 2011-260656

(51) Int. Cl. G02B 6/36

(52) U.S. Cl. 385/88

(57) ABSTRACT

Multiple optical semiconductor devices each outputs light beam corresponding to electric signals. A Peltier element is so provided as to be able to cool the multiple optical semiconductor devices. Resistors are so provided near the optical semiconductor devices as to be able to transfer to one of the optical semiconductor devices heat they produce when energized.

### CROSS-REFERENCE TO RELATED APPLICATION

This application claims the benefit of Japanese Patent Application No. 2011-260656, filed on Nov. 29, 2011, the entire disclosure of which is incorporated by reference herein.

### FIELD

This application relates to an optical module.

### BACKGROUND

It has been known that optical output of optical semiconductor devices used as light beam emitting elements (laser diode elements) is sensitive to the temperature change of the device. As the device temperature changes, the center wavelength of emission alters. For example, as the device temperature drops, the center wavelength of emission shifts to shorter wavelengths.

In this regard, for example, Unexamined Japanese Patent Application Kokai Publication No. H9-148681 discloses an optical module in which a heater is interposed between an optical semiconductor device and a submount to keep the temperature of the optical semiconductor device constantly above the room temperature. The optical module can reduce fluctuation in the center wavelength of emission due to changes in the device temperature.

Furthermore, for example, Unexamined Japanese Patent Application Kokai Publication No. 2001-094200 discloses an optical module in which an optical semiconductor device is mounted on an insulated substrate having a heater function. The optical module can control the optical semiconductor device for a constant temperature by means of heating with the heater.

### SUMMARY

The IEEE (Institute of Electrical and Electronics Engineers) provides the standard ranges of center wavelengths within which emission optical semiconductor devices should comply. However, some optical semiconductor devices may have a center wavelength of emission outside their range due to variations in manufacturing and the like.

If the center wavelength of emission of an optical semiconductor device is shifted to a shorter wavelength, the optical modules disclosed in above Patent Literatures elevate the temperature of the optical semiconductor device by means of a heating element to shift the center wavelength of emission of the optical semiconductor device to a longer wavelength in order to bring it within its standard range. However, if the center wavelength of emission of an optical semiconductor device is shifted to a longer wavelength, the optical semiconductor device must be cooled. In order to cool an optical semiconductor device, a cooling element such as a Peltier element is necessary.

On the other hand, integrated optical modules combining and outputting light beam from multiple optical semiconductor devices have been developed. Temperature control of optical semiconductor devices is also required in such an integrated optical module.

As mentioned above, there is variation in manufacturing in the center wavelength of emission among optical semiconductor devices. Therefore, some optical semiconductor devices may have to have the center wavelength of emission shifted to a shorter wavelength and others may have to have the center wavelength of emission shifted to a longer wavelength in some cases. In other words, an optical module comprising multiple optical semiconductor devices requires individual temperature control on the optical semiconductor devices.

For individual temperature control on the optical semiconductor devices, a Peltier element and temperature-monitoring thermistor must be provided to each optical semiconductor device. A Peltier element and thermistor are significantly large. Therefore, provision of multiple Peltier elements makes the optical module large and increases the cost.

The present invention is invented in view of the above circumstances and an exemplary object of the present invention is to provide an optical module realizing a small size and low cost.

In order to achieve the above object, the optical module according to the present invention comprises:

multiple optical semiconductor devices each outputting light beam corresponding to electric signals;

a cooling element so provided as to be able to cool the multiple optical semiconductor devices; and

multiple resistors so provided near the optical semiconductor devices as to be able to transfer to one of the optical semiconductor devices heat they produce when energized.

According to the present invention, one cooling element cools multiple optical semiconductor devices. Furthermore, resistors transferring to the optical semiconductor devices heat they produce when energized are provided. Then, the temperatures of multiple optical semiconductor devices can be controlled individually simply by providing a resistor substantially smaller than the cooling element to each optical semiconductor device. Consequently, a small-sized, low cost optical module can be realized.

### BRIEF DESCRIPTION OF THE DRAWINGS

A more complete understanding of this application can be obtained when the following detailed description is considered in conjunction with the following drawings, in which:

FIG. 1A is a top view of an optical module according to Embodiment 1 of the present invention;

FIG. 1B is a cross-sectional view of the optical module in FIG. 1A at A-A′;

FIG. 2 is an illustration showing the optical semiconductor device temperature control system of the optical module in FIG. 1A;

FIG. 3 is a chart showing exemplary center wavelengths of emission of the optical semiconductor devices when the operation temperature of the Peltier element is 40° C.;

FIG. 4 is a chart showing exemplary center wavelengths of emission of the optical semiconductor devices when the operation temperature of the Peltier element is 45° C.;

FIG. 5 is a chart showing exemplary center wavelengths of emission of the optical semiconductor devices when a resistor is energized;

FIG. 6A is a top view of an optical module according to Embodiment 2 of the present invention;

FIG. 6B is a cross-sectional view of the optical module in FIG. 6A at A-A′;

FIG. 7 is a chart showing exemplary center wavelengths of emission of the optical semiconductor devices when the operation temperature of the Peltier element is 40° C.;

FIG. 8 is a chart showing exemplary center wavelengths of emission of the optical semiconductor devices when resistors are energized;

FIG. 9 is a chart showing exemplary center wavelengths of emission of the optical semiconductor devices when the operation temperature of the Peltier element is 40° C. in the optical module according to Embodiment 3;

FIG. 10 is a chart showing exemplary center wavelengths of emission of the optical semiconductor devices when the operation temperature of the Peltier element is 38.5° C. in the optical module according to Embodiment 3; and

FIG. 11 is a chart showing exemplary center wavelengths of emission of the optical semiconductor devices when resistors are energized.

### DETAILED DESCRIPTION

Embodiments of the present invention will be described in detail with reference to the drawings.

### Embodiment 1

First, Embodiment 1 of the present invention will be described.

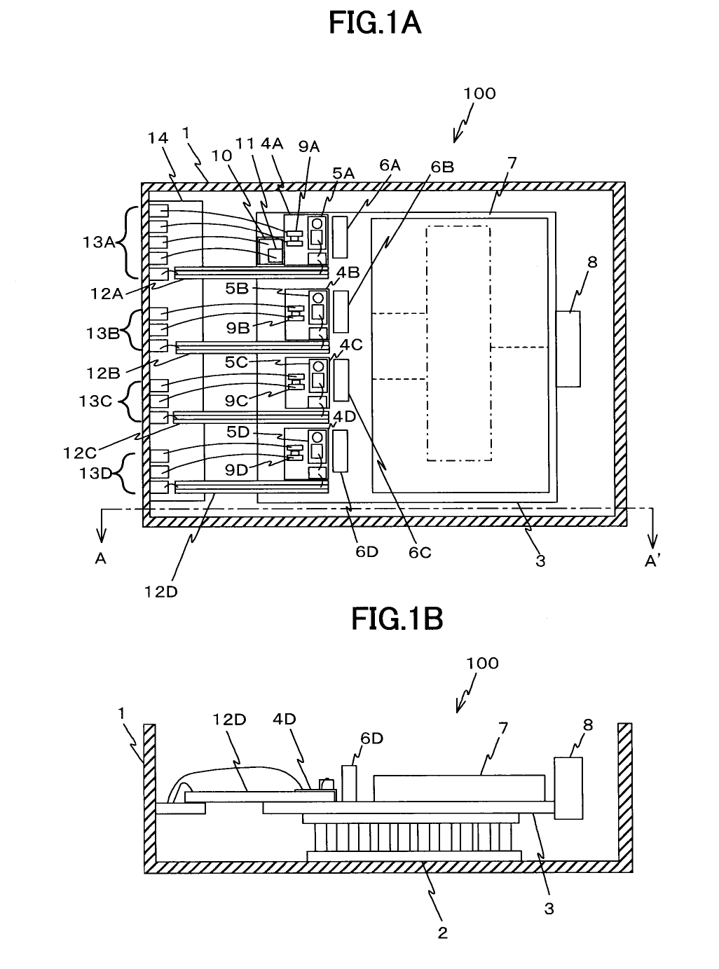

FIGS. 1A and 1B show the structure of an optical module 100 according to an embodiment of the present invention. FIG. 1A is a top view showing the interior of the optical module 100. FIG. 1B is a cross-sectional view of the optical module in FIG. 1A at A-A′. The optical module 100 is integrated into an optical communication device using optical fibers as the transmission medium.

As shown in FIGS. 1A and 1B, the optical module 100 comprises a package 1. The package 1 is the casing of the optical module 100. The package 1 ensures the air tightness of the interior of the optical module 100.

The optical module 100 further comprises a Peltier element 2. As shown in FIG. 1B, the Peltier element 2 is placed on the package 1. One Peltier element 2 is provided. The Peltier element 2 is a cooling element for keeping the temperature of optical semiconductor devices 5A, 5B, 5C and 5D described later constant.

The optical module 100 further comprises a carrier 3. As shown in FIG. 1B, the carrier 3 is placed on the Peltier element 2. The carrier 3 is a substrate on which parts are mounted.

The optical module 100 further comprises LD (laser diode) substrates 4A, 4B, 4C and 4D. As shown in FIG. 1B, the LD substrates 4A to 4D are placed on the carrier 3 (behind a transfer line substrate 12D in the figure). The LD substrate 4A is a substrate on which an optical semiconductor device 5A described later is mounted. The LD substrate 4B is a substrate on which an optical semiconductor device 5B described later is mounted. The LD substrate 4C is a substrate on which an optical semiconductor device 5C described later is mounted. The LD substrate 4D is a substrate on which an optical semiconductor device 5D described later is mounted.

As shown in FIG. 1A, the optical module 100 further comprises four optical semiconductor devices 5A, 5B, 5C and 5D. In other words, the optical module 100 is an integrated optical module in which multiple optical semiconductor devices 5A to 5D are mounted.

As described above, a single Peltier element 2 is mounted for multiple optical semiconductor devices 5A to 5D in the optical module 100. The Peltier element 2 is so mounted as to be able to cool the multiple optical semiconductor devices 5A to 5D via the carrier 3.

As described above, the optical semiconductor devices 5A to 5D are mounted on the LD substrates 4A to 4D. The optical semiconductor devices 5A to 5D are optical semiconductor devices conducting electro-optic conversion. The optical semiconductor device 5A converts input electric signals to optical signals having a given center wavelength band of emission and outputs the optical signals.

The optical semiconductor device 5B is an optical semiconductor device having a center wavelength band of emission different from that of the optical semiconductor device 5A. The optical semiconductor device 5C is an optical semiconductor device having a center wavelength band of emission different from those of the optical semiconductor devices 5A and 5B. The optical semiconductor device 5D is an optical semiconductor device having a center wavelength band of emission different from those of the optical semiconductor devices 5A, 5B and 5C.

The optical module 100 further comprises lenses 6A, 6B, 6C and 6D. As shown in FIG. 1B, the lenses 6A to 6D are placed on the carrier 3. The lens 6A collects light beam emitted from the optical semiconductor device 5A. The lens 6B collects light beam emitted from the optical semiconductor device 5B. The lens 6C collects light beam emitted from the optical semiconductor device 5C. The lens 6D collects light beam emitted from the optical semiconductor device 5D.

The optical module 100 further comprises an optical multiplexer 7. As shown in FIG. 1B, the optical multiplexer 7 is placed on the carrier 3. The optical multiplexer 7 combines multiple light beams collected by the lenses 6A, 6B, 6C and 6D into a single light beam to be outputted.

The optical module 100 further comprises a lens 8. As shown in FIG. 1B, the lens 8 is connected and fixed to an end of the carrier 3. The lens 8 is a relay lens for the light beam output from the optical multiplexer 7 to enter an optical fiber or the like. The light beam entering the optical fiber is transferred to the reception end through the optical fiber.

As shown in FIG. 1A, the optical module 100 further comprises resistors 9A, 9B, 9C and 9D. The resistor 9A is placed on the LD substrate 4A near the optical semiconductor device 5A. Heat produced by the energized resistor 9A is transmitted to the optical semiconductor device 5A but not to the other optical semiconductor devices 5B, 5C and 5D. The resistor 9B is placed near the optical semiconductor device 5B. Heat produced by the energized resistor 9B is transmitted to the optical semiconductor device 5B but not to the other optical semiconductor devices 5A, 5C and 5D. The resistor 9C is placed near the optical semiconductor device 5C. Heat produced by the energized resistor 9C is transmitted to the optical semiconductor device 5C but not to the other optical semiconductor devices 5A, 5B and 5D. The resistor 9D is placed near the optical semiconductor device 5D. Heat produced by the energized resistor 9D is transmitted to the optical semiconductor device 5D but not to the other optical semiconductor devices 5A, 5B and 5C.

The optical module 100 further comprises a thermistor substrate 10 and a thermistor 11. As shown in FIG. 1A, the thermistor substrate 10 is installed on the LD substrate 4A. The thermistor substrate 10 is a substrate on which the thermistor 11 is mounted. The thermistor 11 is a chip part monitoring the temperature of the optical semiconductor device 4A.

The optical module 100 further comprises transfer line substrates 12A, 12B, 12C and 12D. As shown in FIG. 1A, the transfer line substrates 12A to 12D are provided to connect the LD substrates 4A to 4D and a feed-through 14 described later. The transfer line substrate 12A is a substrate transferring electric signals to the optical semiconductor device 5A. The transfer line substrate 12B is a substrate transferring electric signals to the optical semiconductor device 5B. The transfer line substrate 12C is a substrate transferring electric signals to the optical semiconductor device 5C. The transfer line substrate 12D is a substrate transferring electric signals to the optical semiconductor device 5D.

The optical module 100 further comprises a feed-through 14. The feed-through 14 comprises multiple electrodes 13A, 13B, 13C and 13D. The electrodes 13A to 13D include electrodes receiving electric signals corresponding to data to transmit. The electric signals received by such electrodes are transferred to the optical semiconductor devices 5A, 5B, 5C and 5D via the transfer line substrates 12A to 12D.

The other electrodes on the feed-through 14 are connected to the resistors 9A, 9B, 9C and 9D, thermistor 11, and the like. Necessary power is supplied to the resistors 9A, 9B, 9C, and 9D, thermistor substrate 10, thermistor 11, and the like via these electrodes.

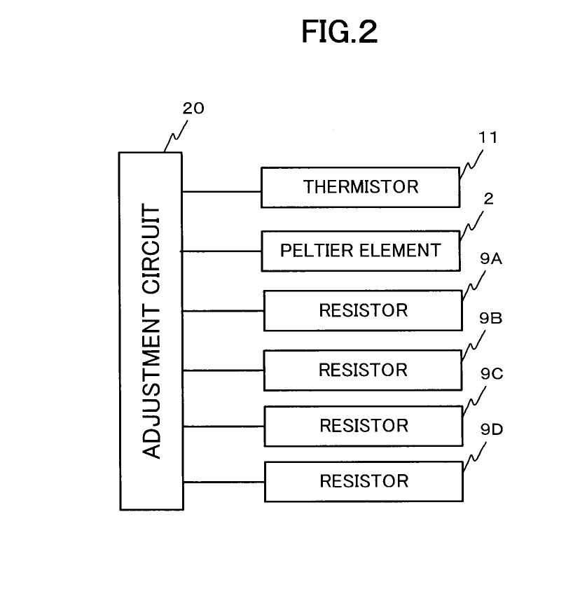

FIG. 2 shows the structure of the system controlling the operation temperature of the optical semiconductor devices 5A to 5D in the optical module 100. As shown in FIG. 2, the operation temperature of the optical semiconductor devices 5A to 5D is adjusted by an adjustment circuit 20. The adjustment circuit 20 can be placed outside or inside the optical module 100.

The adjustment circuit 20 adjusts the operation temperature of the Peltier element 2 based on the temperature monitored by the thermistor 11. With the operation temperature being changed, the center wavelengths of emission of all optical semiconductor devices 5A to 5D are shifted to longer wavelengths or to shorter wavelengths. Furthermore, the adjustment circuit 20 energizes the resistor 9A, 9B, 9C or 9D as necessary to cause it to produce heat so that the center wavelengths of emission of the optical semiconductor devices 5A to 5D are individually shifted to longer wavelengths or to the shorter wavelengths.

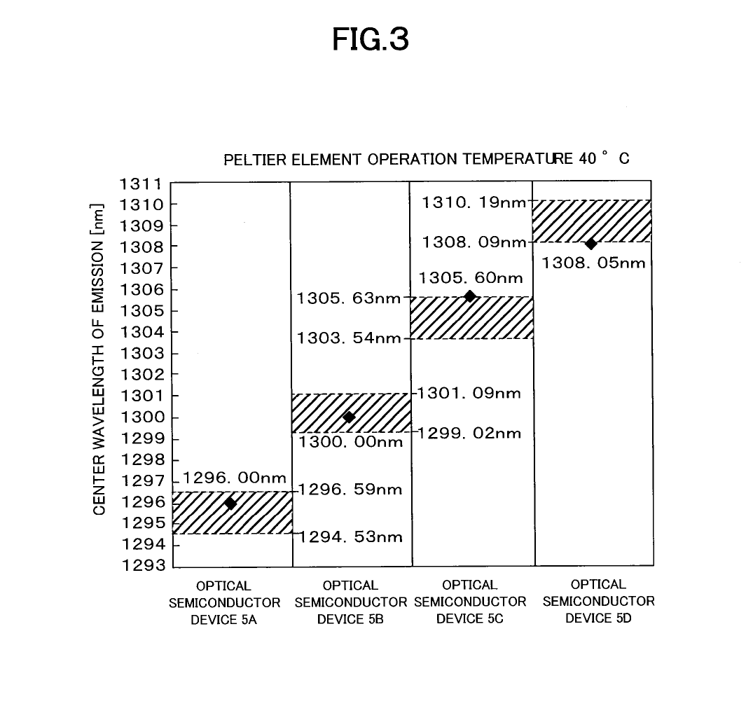

The center wavelengths of emission of the optical semiconductor devices 5A to 5D vary due to variation upon manufacturing or variation in the temperature profile on the carrier 3. FIG. 3 shows exemplary center wavelengths of emission of the optical semiconductor devices 5A to 5D when the operation temperature of the Peltier element 2 is 40° C. As shown in FIG. 3, the center wavelengths of emission of the optical semiconductor devices 5A and 5D are 1296.00 nm, 1300.00 nm, 1305.60 nm and 1308.05 nm, respectively.

The IEEE (Institute of Electrical and Electronics Engineers) provides the standard ranges of center wavelengths of emission the optical semiconductor devices 5A to 5D should comply with. In FIG. 3, the ranges of center wavelengths of emission for the optical semiconductor devices 5A to 5D based on the IEEE 802.3, 100 GBASE-ER4 are shaded.

As shown in FIG. 3, the optical semiconductor device 5A should fall within a range from 1294.53 nm to 1296.59 nm (a width Δ of 2.06 nm). The optical semiconductor device 5B should fall within a range from 1299.02 nm to 1301.09 nm (a width Δ of 2.07 nm). The optical semiconductor device 5C should fall within a range from 1303.54 nm to 1305.63 nm (a width Δ of 2.09 nm). The optical semiconductor device 5D should fall within a range from 1308.09 nm to 1310.19 nm (a width Δ of 2.10 nm).

As shown in FIG. 3, when the operation temperature of the Peltier element 2 is 40° C., the center wavelengths of emission of the optical semiconductor devices 5A, 5B, and 5C fall within their standard ranges. On the other hand, the center wavelength of emission of the optical semiconductor device 5D is 1308.05 nm, which is shifted to a shorter wavelength outside its standard range.

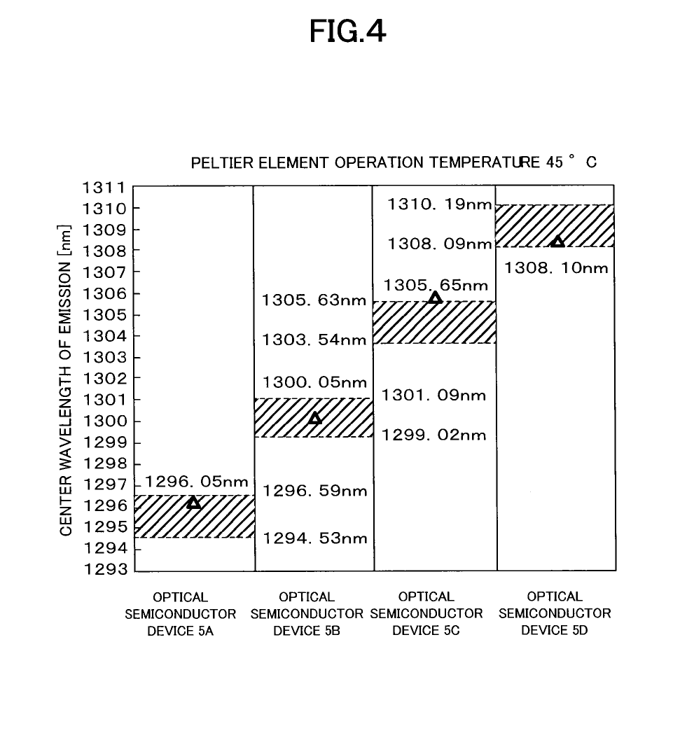

Then, it is assumed that the operation temperature of the Peltier element 2 is raised by 5° C. in order to shift the emission center wavelength of the optical semiconductor device 5D to its longer side to meet its standard range. FIG. 4 shows exemplary center wavelengths of emission of the optical semiconductor devices in such a case. As shown in FIG. 4, the operation temperatures of all optical semiconductor devices 5A to 5D are elevated by 5° C.; therefore, the center wavelengths of emission of the optical semiconductor devices 5A to 5D are each shifted to longer wavelengths by +0.05 nm.

In this way, as shown in FIG. 4, the center wavelength of emission of the optical semiconductor device 5D is changed to 1308.10 nm, which falls within its standard range. However, conversely, the center wavelength of emission of the optical semiconductor device 5C, which was within its standard range, is changed to 1305.65 nm, which falls outside its standard range (from 1303.54 nm to 1305.63 nm).

Then, in this embodiment, the adjustment circuit 20 sends an electric current to the resistor 9D placed near the optical semiconductor device 5D that did not meet its standard range at first (in the state of FIG. 3) in order for all optical semiconductor devices 5A to 5D to meet their standard center wavelengths of emission. With the resistor 9D being energized, the following heat P is produced:

P=R×I²[W] (1)

in which R is the resistance [Ω] of the resistor 9D and I is the current [A] flowing through the resistor 9D.

Here, the values of various parameters in the optical module 100 according to this embodiment are listed in Table 1 below.

TABLE 1
Values of various parameters in the optical module 100

| item | value | unit |
|---|---|---|
| Resistor 9D, height | 0.2 | mm |
| Resistor 9D, width | 0.1 | mm |
| LD substrate 4D, thickness | 0.2 | mm |
| LD substrate 4D, heat conductivity | 170 | W/m · k |
| LD substrate 4D, thermal resistance | 15.0 | ° C./W |
| Resistor 9D, resistance | 100 | Ω |
| Resistor 9D, current | 0.05 | A |
| Resistor 9D, heat to produce P | 0.25 | W |
| Optical semiconductor device 5D, | 3.8 | ° C. |
| elevation of operation temperature | | |
| Optical semiconductor device 5D, shift of | 0.38 | nm |
| center wavelength of emission | | |

As shown in the above Table 1, when the resistance of the resistor 9D is 100Ω and the current flowing through the resistor 9D is 0.05 A, the resistor 9D produces 0.25 W of heat P. In such a case, only the operation temperature of the optical semiconductor device 5D is elevated by 3.8° C.

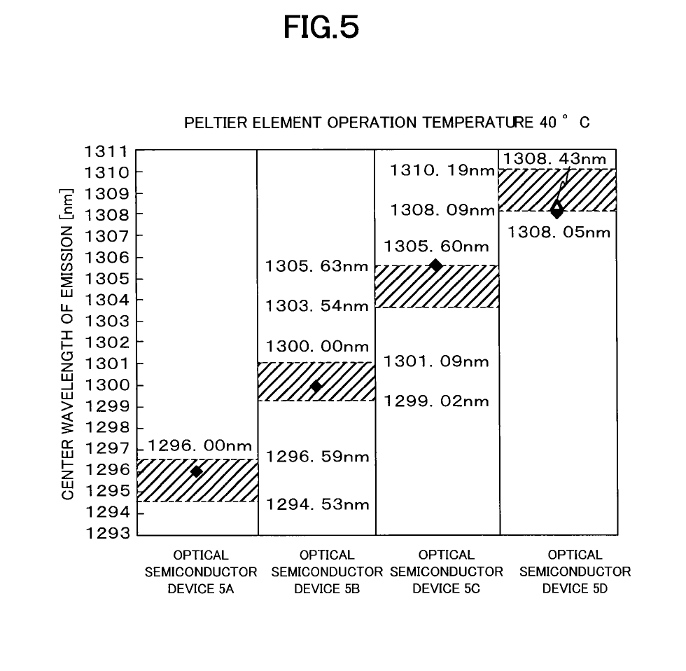

FIG. 5 shows exemplary center wavelengths of the optical semiconductor devices 5A to 5D when the operation temperature of the Peltier element 2 is 40° C. and the resistor 9D is energized. As shown in FIG. 5, because the optical semiconductor devices 5A to 5C are far away from the resistor 9D, their center wavelengths of emission do not change before and after the resistor 9D is energized. On the other hand, because of the heat produced by the resistor 9D, the center wavelength of emission of the optical semiconductor device 5D is shifted by 0.38 nm to a longer wavelength of 1308.43 nm. Consequently, the center wavelength of emission of the optical semiconductor device 5D falls within its standard range.

As described above, the optical module 100 according to this embodiment is an integrated optical module in which multiple optical semiconductor devices 5A to 5D are mounted on a single Peltier element 2. In the optical module 100, among the optical semiconductor devices 5A to 5D, those that do not meet their standard center wavelength of emission due to variation upon manufacturing or variation in the temperature profile on the carrier 3 can be adjusted individually to meet their standard center wavelength of emission by means of heat produced by the resistors 6A to 6D placed near the optical semiconductor devices 5A to 5D. In other words, in this embodiment, the temperatures of multiple optical semiconductor devices 5A to 5D can be controlled individually simply by placing the resistors 9A to 9D, substantially smaller than the Peltier element 2, near the optical semiconductor devices, respectively. Consequently, the optical module 100 can be reduced in size and cost.

In this embodiment, the center wavelength of emission of the optical semiconductor device 5D is adjusted. The same scheme is applicable to the optical semiconductor devices 5A, 5B and 5C. Furthermore, two or more resistors may be energized simultaneously.

### Embodiment 2

Embodiment 2 of the present invention will be described hereafter.

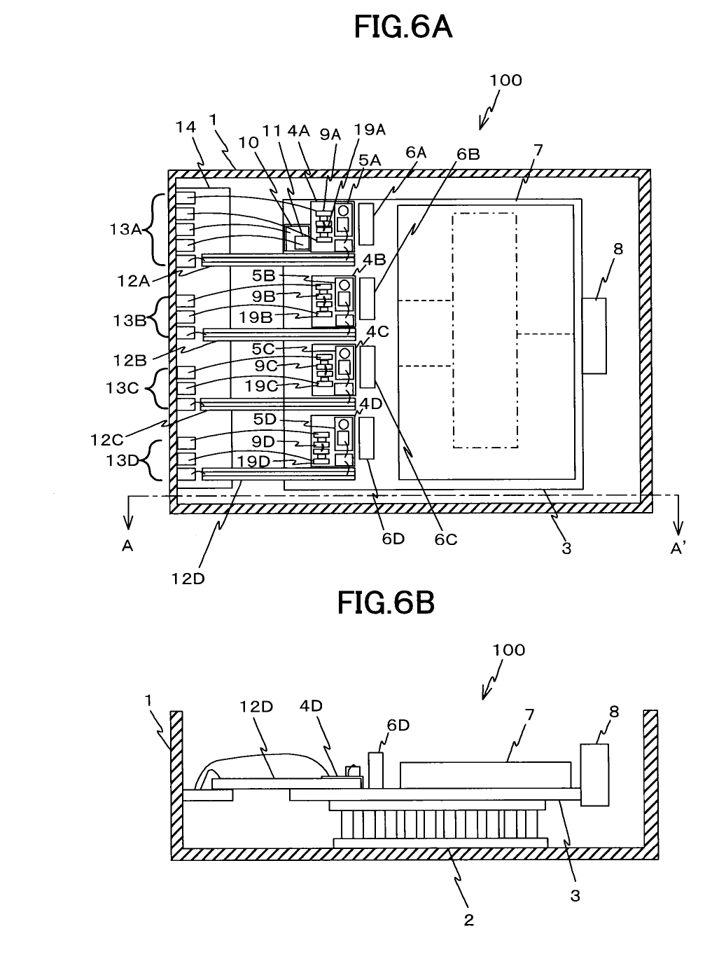

FIGS. 6A and 6B show the structure of an optical module 100 according to this embodiment. The optical module 100 according to this embodiment is different from the optical module 100 according to the above Embodiment 1 (see FIGS. 1A and 1B) in that as shown in FIG. 6A, resistors 19A, 19B, 19C and 19D are further provided on the LD substrates 4A, 4B, 4C and 4D near the optical semiconductor devices 5A, 5B, 5C and 5D in addition to the resistors 9A, 9B, 9C and 9D.

The resistors 9A and 19A, resistors 9B and 19B, resistors 9C and 19C, and resistors 9D and 19D are series-connected, respectively. The adjustment circuit (see FIG. 2) powers the resistors 9A and 19A, resistors 9B and 19B, resistors 9C and 19C, and resistors 9D and 19D via electrodes 13A, 13B, 13C and 13D, respectively.

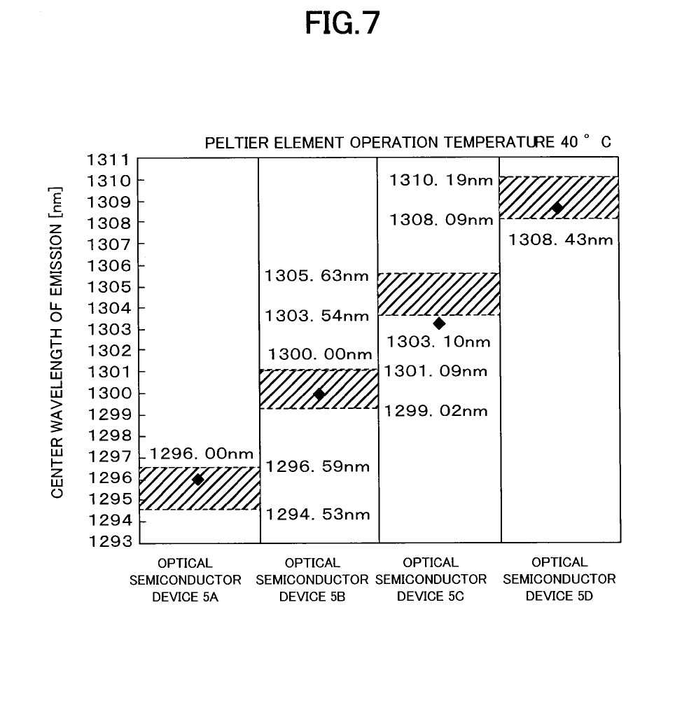

FIG. 7 shows exemplary center wavelengths of the optical semiconductor devices 5A to 5D when the operation temperature of the Peltier element 2 is 40° C. As shown in FIG. 7, the center wavelengths of emission of the optical semiconductor devices 5A, 5B and 5D fall within their standard ranges. However, the center wavelength of emission of the optical semiconductor device 5C is 1303.10 nm, which is shifted to a shorter wavelength outside its standard range. Such variation in the center wavelength of emission occurs due to variation upon manufacturing of the optical semiconductor devices 5A, 5B, 5C and 5D or variation in the temperature profile on the carrier 3.

Here, the values of various parameters in the optical module 100 according to this embodiment are listed in Table 2 below.

TABLE 2
Values of various parameters in the optical module 100

| Item | value | unit |
|---|---|---|
| Resistors 9C and 19C, height | 0.2 | mm |
| Resistors 9C and 19C, width | 0.1 | mm |
| LD substrate 4C, thickness | 0.2 | mm |
| LD substrate 4C, heat conductively | 170 | W/m · k |
| LD substrate 4C, thermal resistance | 15.0 | ° C./W |
| Resistor 9C, resistance | 100 | Ω |
| Resistor 19C, resistance | 100 | Ω |
| Resistors 9C and 19C, current | 0.05 | A |
| Resistors 9C and 19C, heat to produce | 0.5 | W |
| (total of the two) | | |
| Optical semiconductor device 5C, | 7.5 | ° C. |
| elevation of operation temperature | | |
| Optical semiconductor device 5C, shift of | 0.75 | nm |
| center wavelength of emission | | |

If the current flowing through the resistor 9C is limited to 0.05 A, as in the above Embodiment 1, one resistor can shift the center wavelength of emission by 0.38 nm (see Table 1). In such a case, the center wavelength of emission of the optical semiconductor device 9C is shifted from 1303.10 nm to 1303.48 nm. This shift amount does not meet the lower limit of the standard range, 1303.54, or above.

Then, in this embodiment, two resistors 9C and 19C are series-connected and energized by the adjustment circuit 20. Then, as shown in the above Table 2, the heat to be produced upon energizing is doubled compared with the above Embodiment 1. Consequently, the center wavelength of emission of the optical semiconductor device 5C can be shifted more than in the above Embodiment 1.

As shown in the above Table 2, when the total resistance of the resistors 9C and 19C is 100Ω×2 and the current is 0.05 A, the resistors 9C and 19C produce a total of 0.5 W of heat. The element temperature of the optical semiconductor device 5C can be elevated by 7.5° C.

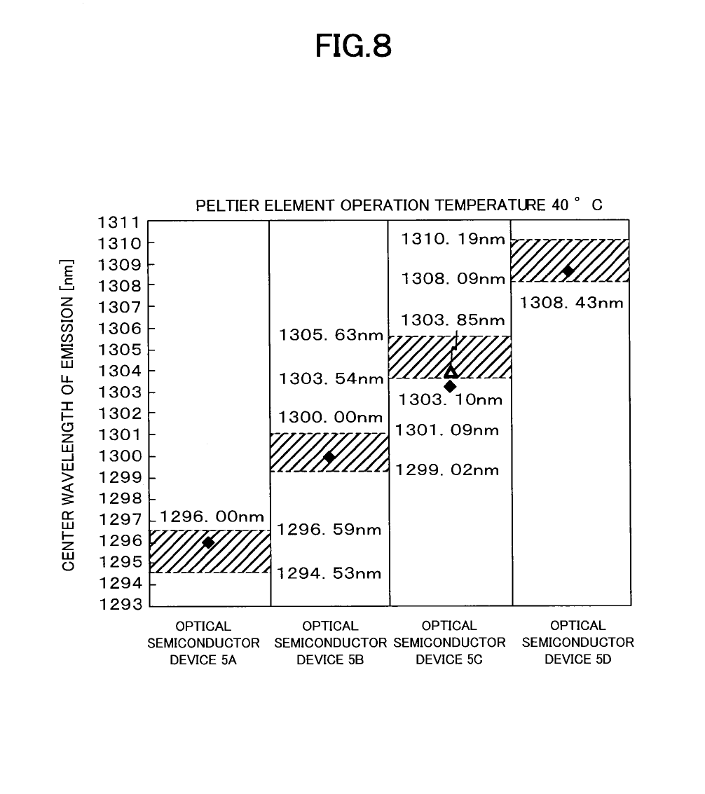

FIG. 8 shows exemplary center wavelengths of emission of the optical semiconductor devices when the resistors 9C and 19C are energized. As shown in FIG. 8, with the resistors 9C and 19C being energized, the center wavelength of emission of the optical semiconductor device 5C can be shifted by 0.75 nm to a longer wavelength of 1303.85 nm, which falls within its standard range.

As described above in detail, in this embodiment, the center wavelengths of emission of the optical semiconductor devices 5A to 5D can be shifted more by providing two or more resistors (the resistors 9A and 19A and the like) corresponding to the optical semiconductor devices 5A to 5D.

In this embodiment, the center wavelength of emission of the optical semiconductor device 5C is adjusted. The same scheme is applicable to the optical semiconductor devices 5A, 5B, and 5D. Furthermore, two or more resistors can be energized simultaneously.

### Embodiment 3

Embodiment 3 of the present invention will be described hereafter.

The optical module 100 according to this embodiment has the same structure as the optical module of the above Embodiment 2 (see FIGS. 6A and 6B). In other words, the resistors 9A and 19A, resistors 9B and 19B, resistors 9C and 19C, and resistors 9D and 19D are provided near the optical semiconductor devices 5A, 5B, 5C and 5D and series-connected, respectively, as in the above Embodiment 2.

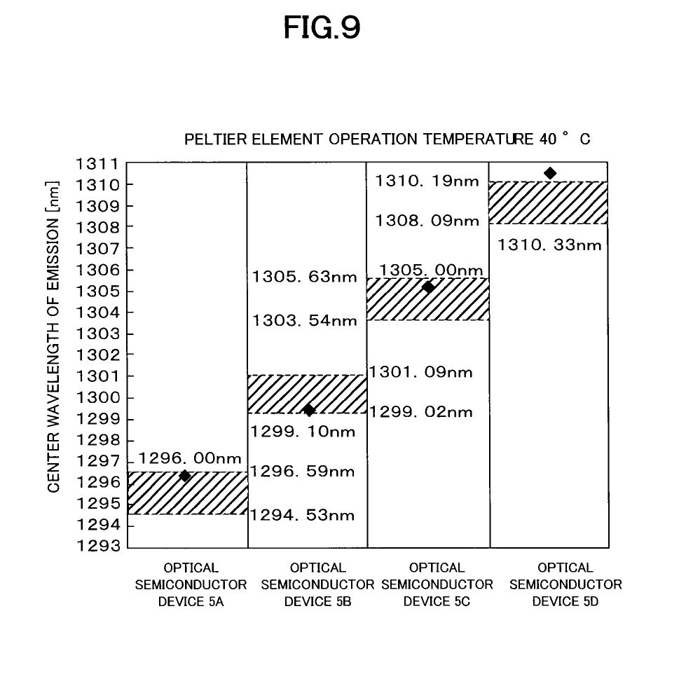

FIG. 9 shows exemplary variation in the center wavelengths of emission of the optical semiconductor devices 5A to 5D in the optical module 100 according to this embodiment. In FIG. 9, the operation temperature of the Peltier element 2 is 40° C. As shown in FIG. 9, the optical semiconductor devices 5A, 5B and 5C meet their standard ranges while the center wavelength of emission of the optical semiconductor device 5D is 1310.33 nm, which is outside its standard range (shifted to longer wavelengths). Such variation occurs, as mentioned above, due to variation upon manufacturing of the optical semiconductor devices 5A to 5D or variation in the temperature profile on the carrier 3.

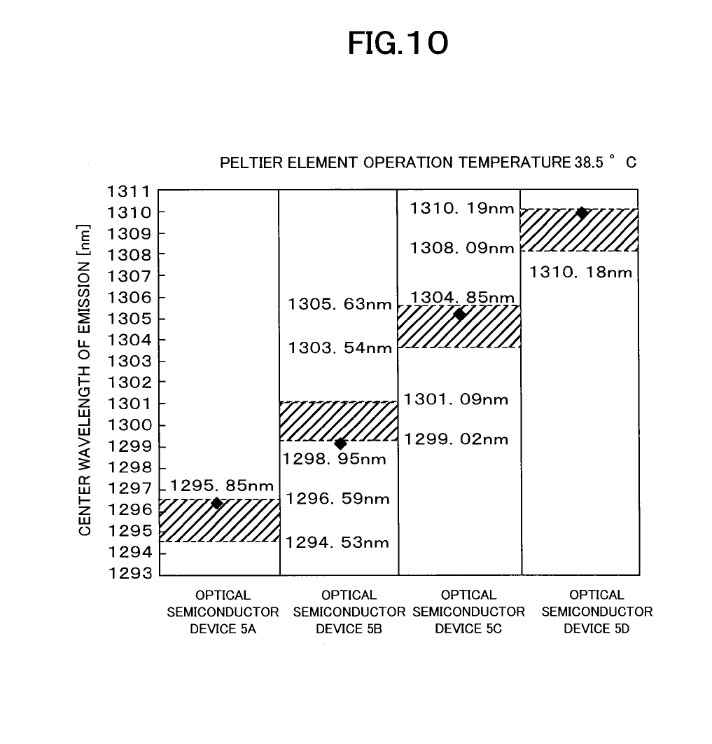

FIG. 10 shows exemplary variation in the center wavelengths of emission of the optical semiconductor devices 5A to 5D after the operation temperature of the Peltier element 2 is adjusted to 38.5° C. from 40° C. As shown in FIG. 10, as the adjustment circuit 20 adjusts the operation temperature of the Peltier element 2 from 40° C. to 38.5° C., the center wavelengths of emission of the optical semiconductor devices 5A to 5D are shifted to shorter wavelengths by 0.15 nm. In this case, the center wavelength of emission of the optical semiconductor device 5D among the optical semiconductor devices 5A to 5D, which was shifted to a longer wavelength outside its standard range, comes to fall within its standard range. However, the center wavelength of emission of the optical semiconductor device 5B is changed to 1298.95 nm, which is outside its standard range (shifted to shorter wavelengths).

Here, the values of various parameters in the optical module 100 according to this embodiment are listed in Table 3 below.

TABLE 3
Values of various parameters in the optical module 100

| Item | value | unit |
|---|---|---|
| Resistors 9B and 19B, height | 0.2 | mm |
| Resistors 9B and 19B, width | 0.1 | mm |
| LD substrate 4B, thickness | 0.2 | mm |
| LD substrate 4B, heat conductively | 170 | W/m · k |
| LD substrate 4B, thermal resistance | 15.0 | ° C./W |
| Resistor 9B, resistance | 100 | Ω |
| Resistor 19B, resistance | 100 | Ω |
| Resistors 9B and 19B, current | 0.05 | A |
| Resistors 9B and 19B, heat to produce | 0.5 | W |
| (total of the two) | | |
| Optical semiconductor device 5B, | 7.5 | ° C. |
| elevation of operation temperature | | |
| Optical semiconductor device 5B, shift of | 0.75 | nm |
| center wavelength of emission | | |

As shown in the above Table 3, when the current is 0.05 A, the resistors 9B and 19B produce 0.5 W of heat. Then, the element temperature of the optical semiconductor device 5B is elevated by 7.5° C.

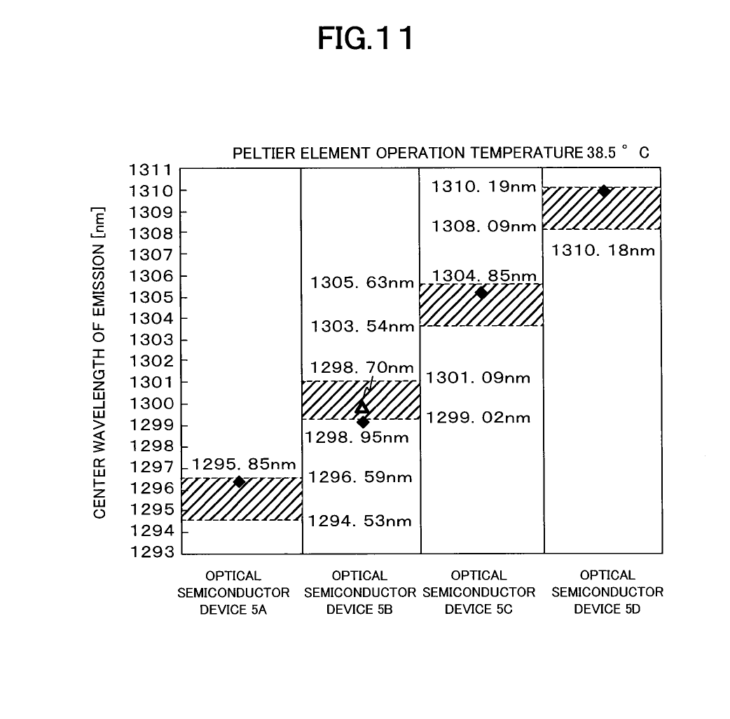

FIG. 11 shows exemplary center wavelengths of emission of the optical semiconductor devices when the resistors 9B and 19B are energized. As shown in FIG. 11, only the center wavelength of emission of the optical semiconductor device 5B is shifted by 0.75 nm to a longer wavelength of 1299.70 nm. Consequently, the center wavelength of emission of the optical semiconductor device 5B falls within its standard range. Then, the center wavelengths of emission of all optical semiconductor devices 5A to 5D fall within their standard ranges.

As described above in detail, in this embodiment, the operation temperature of the Peltier element 2 is adjusted so that the center wavelengths of emission of some optical semiconductor devices, which were shifted to longer wavelengths falling outside their standard ranges, come to fall within their standard ranges. If this adjustment causes some optical semiconductor devices to shift to shorter wavelengths falling outside their standard ranges, the adjustment circuit 20 energizes the resistors near such optical semiconductor devices so as to shift their center wavelengths of emission to longer wavelengths falling within their standard ranges. Consequently, the center wavelengths of emission of all optical semiconductor devices fall within their standard ranges.

In this embodiment, the center wavelength of emission of the optical semiconductor device 5B is adjusted. The same scheme is applicable to the optical semiconductor devices 5A, 5C, and 5D. Furthermore, two or more resistors can be energized simultaneously.

Here, the adjustment circuit 20 may adjust the operation temperature of the Peltier element 2 so that the number of optical semiconductor devices having a center wavelength of emission falling within their given standard range among the optical semiconductor devices 5A to 5D is maximized. In such a case, if some optical semiconductor devices do not meet their given standard range, the adjustment circuit 20 energizes the resistors corresponding to such optical semiconductor devices so that the center wavelengths of emission of all optical semiconductor devices 5A to 5D fall within their standard ranges.

Here, the number of resistors provided for each optical semiconductor device is not limited to one or two, and three or more resistors can be provided. Furthermore, the resistors can be parallel-connected. However, it is desirable to series-connect the resistors for increasing the total heat to be produced.

The parameters of the optical module 100 are not limited to those shown in Tables 1, 2, and 3, and are properly determined according to the substrates, resistors and the like employed in the optical module 100. In addition, the specific numbers used in the above embodiments are given absolutely by way of example.

In the above embodiments, four optical semiconductor devices are provided. The present invention is not confined thereto. Two, three, five or more optical semiconductor devices can be provided. The bottom line is that multiple optical semiconductor devices are provided.

In the above embodiments, the optical semiconductor devices 5A to 5D have different center wavelengths of emission from each other. Some or all of the center wavelengths of emission can be equal.

Various embodiments and modifications are available for the present invention without departing from the broad sense of spirit and scope of the present invention. The above embodiments are presented for explaining the present invention and do not limit the scope of the present invention. In other words, the scope of the present invention is set forth in the scope of claims, not in the embodiments. Various modifications made within the scope of claims and within the scope of significance of the invention equivalent to the claims are considered to fall under the scope of the present invention.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

The present invention is suitable for, for example, optical modules used in optical communication and the like.

### LEGEND

1 Package
2 Peltier element
3 Carrier
4A, 4B, 4C, 4D LD Substrate
5A, 5B, 5C, 5D Optical semiconductor device
6A, 6B, 6C, 6D Lens
7 Optical multiplexer
8 Lens
9A, 9B, 9C, 9D Resistor
10 Thermistor substrate
11 Thermistor
12A, 12B, 12C, 12D Transfer line substrate
13A, 13B, 13C, 13D Electrode
14 Feed-through
20 Adjustment circuit
100 Optical module

What is claimed is:

1. An optical module, comprising:
multiple optical semiconductor devices each outputting light beam corresponding to electric signals;
a cooling element so provided as to be able to cool said multiple optical semiconductor devices; and
multiple resistors so provided near said respective optical semiconductor devices as to be able to transfer to one of said optical semiconductor devices heat they produce when energized.

2. The optical module according to claim 1, wherein:
a plurality of said resistors are provided to each of said optical semiconductor devices.

3. The optical module according to claim 1, further comprising:
an adjustment circuit adjusting the operation temperature of said cooling element and the energization of said multiple resistors.

4. The optical module according to claim 3, wherein said adjustment circuit
adjusts the operation temperature of said cooling element so that those having a center wavelength of emission shifted to longer wavelengths falling outside their given standard range among said multiple optical semiconductor devices come to have a center wavelength of emission falling within their given standard range, and
energizes the resistors corresponding to the optical semiconductor devices not meeting their given standard ranges.

5. The optical module according to claim 3, wherein said adjustment circuit adjusts the operation temperature of said cooling element so that the number of optical semiconductor devices having a center wavelength of emission falling within their given standard range among said multiple optical semiconductor devices is maximized, and
energizes the resistors corresponding to the optical semiconductor devices not meeting their given standard ranges.

6. The optical module according to claim 1, wherein:
said multiple optical semiconductor devices have different center wavelengths of emission from each other.
